(19) United States
(12) Patent Application Publication
(10) Pub. No.: US 2015/0379494 A1
(43) Pub. Date: Dec. 31, 2015

(54) INFORMATION PROCESSING SYSTEM, AND INFORMATION PROCESSING METHOD

(71) Applicant: NEC CORPORATION, Tokyo (JP)

(72) Inventors: Noriyoshi HIROI, Tokyo (JP); Kan ARAI, Tokyo (JP)

(21) Appl. No.: 14/765,596

(22) PCT Filed: Dec. 13, 2013
(86) PCT No.: PCT/JP2013/083520

§ 371 Date: Aug. 4, 2015

(30) Foreign Application Priority Data
Mar. 1, 2013 (JP) 2013-040620
Mar. 1, 2013 (JP) 2013-040623

(51) Int. Cl. G06Q 20/20; G06K 9/46; G06T 7/00; H04N 7/18; H04N 5/232

(52) U.S. Cl. CPC G06Q 20/20; H04N 7/18; H04N 5/23293; G06T 7/004; G06K 9/46

(57) ABSTRACT

An information processing system includes, a first detection unit which detects an object position which is the position of an object, and a display control unit which causes information based on the type of the object or the type of a content contained in the object to be displayed in the object position or near the object position.

### TECHNICAL FIELD

Some aspects of the present invention relate to an information processing system and an information processing method.

### BACKGROUND ART

As a related technique, a checkout system has been contemplated (see PTL 1, for example). The checkout system recognizes all of the products on a tray at the time of purchase of products such as donuts, for example, and displays to confirm whether or not the recognition of each of the products is correct. And the checkout system processes information such as the prices for the products in accordance with an input for the display. In such the checkout system, a purchaser places the tray on which the products are placed in front of a terminal that constitutes a POS (Point Of Sale) system (hereinafter referred to as the POS terminal), then confirms whether the product has been correctly identified, and then makes the payment or performs other transactions.

As another related technique, a system has been contemplated in which product information about products is displayed near the products arranged in a showcase or on the surfaces of the products (see PTL 2, for example). PTL 2 discloses a system in which the position and product code of a product are identified to enable a projector or other projection equipment to project character strings such as “New”, “Made in France”, or “Most popular selling” or related information about related products onto a location near the product or onto the surface of the product.

### CITATION LIST

### Patent Literature

PTL 1: Japanese Laid-open Patent Publication No. 2013-030202

PTL 2: Japanese Laid-open Patent Publication No. 2005-156591

### SUMMARY OF INVENTION

### Technical Problem

However, the approach described in PTL 1 does not indicates the total amount to pay until the customer reaches the POS terminal and therefore the customer cannot prepare cash to hand over until the customer reaches a location close to the POS terminal. In this checkout process, other purchasers standing in the checkout line has to wait while the customer is preparing cash, which prolongs the wait time. In other words, customer satisfaction may decrease because information is not suitably provided.

The approach described in PTL 2 does not take into consideration changes in the locations of products. For example, when a customer (user) has picked up a product, product information is still displayed on its original location. Accordingly, the customer's attention may be attracted to only one of the product itself or the product information while the customer is holding the product.

Some aspects of the present invention have been made in light of the problems described above and an object of the present invention is to provide an information processing system and an information processing method that enable information to be suitably provided to users.

### Solution to Problem

An information processing system according to an exemplary aspect of the present invention includes: a first detection means for detecting an object position which is the position of an object; and a display control means for causing information based on the type of the object or the type of a content contained in the object to be displayed in the object position of the object or near the object position.

An information processing method according to an exemplary aspect of the present invention includes the steps of: detecting an object position which is the position of an object; and causing information based on the type of the object or the type of a content contained in the object to be displayed in the object position of the object or near the object position.

Note that the terms “unit”, “means”, “device” and “system” as used herein not only refer to physical means but also encompasses software implementations of functions of the “unit”, “means”, “device” and “system”. Functions of one “unit”, “means”, “device” or “system” may be implemented by more than two physical means or device or functions of more than two “units”, “means”, “devices” or “systems” may be implemented by one physical means or device.

### Advantageous Effects of Invention

The present invention provides an information processing system and an information processing method that enable information to be suitably provided to users.

### BRIEF DESCRIPTION OF DRAWINGS

FIG. 1 is a diagram for outlining the display system according to a first exemplary embodiment.

FIG. 2 is a functional block diagram illustrating a general configuration of the display system according to the first exemplary embodiment.

FIG. 3 is a flowchart illustrating a flow of processing by a control device illustrated in FIG. 2.

FIG. 4 is a block diagram illustrating a configuration of hardware capable of implementing the control device illustrated in FIG. 3.

FIG. 5 is a diagram for outlining a display system according to a second exemplary embodiment.

FIG. 6 is a flowchart illustrating a flow of processing by a control device illustrated in FIG. 2.

FIG. 7 is a diagram for outlining a display system according to a third exemplary embodiment.

FIG. 8 is a functional block diagram illustrating a general configuration of an information processing system according to a fourth exemplary embodiment.

FIG. 9 is a diagram for outlining a display system according to a fifth exemplary embodiment.

FIG. 10 is a functional block diagram illustrating a general configuration of the display system according to the fifth exemplary embodiment.

FIG. 11 is a flowchart illustrating a flow of processing by a control device illustrated in FIG. 10.

FIG. 12 is a block diagram illustrating a configuration of hardware capable of implementing a control device illustrated in FIG. 11.

FIG. 13 is a diagram for outlining a display system according to a sixth exemplary embodiment.

FIG. 14 is a flowchart illustrating a flow of processing by a control device illustrated in FIG. 13.

FIG. 15 is a functional block diagram illustrating a general configuration of an information processing system according to a seventh exemplary embodiment.

FIG. 16 is a functional block diagram illustrating a general configuration of an information processing system according to an eighth exemplary embodiment.

### DESCRIPTION OF EXEMPLARY EMBODIMENTS

Exemplary embodiments of the present invention will be described below. The same or corresponding components are given the same or similar reference numerals in the following description and drawings referred to.

### 1 First Exemplary Embodiment

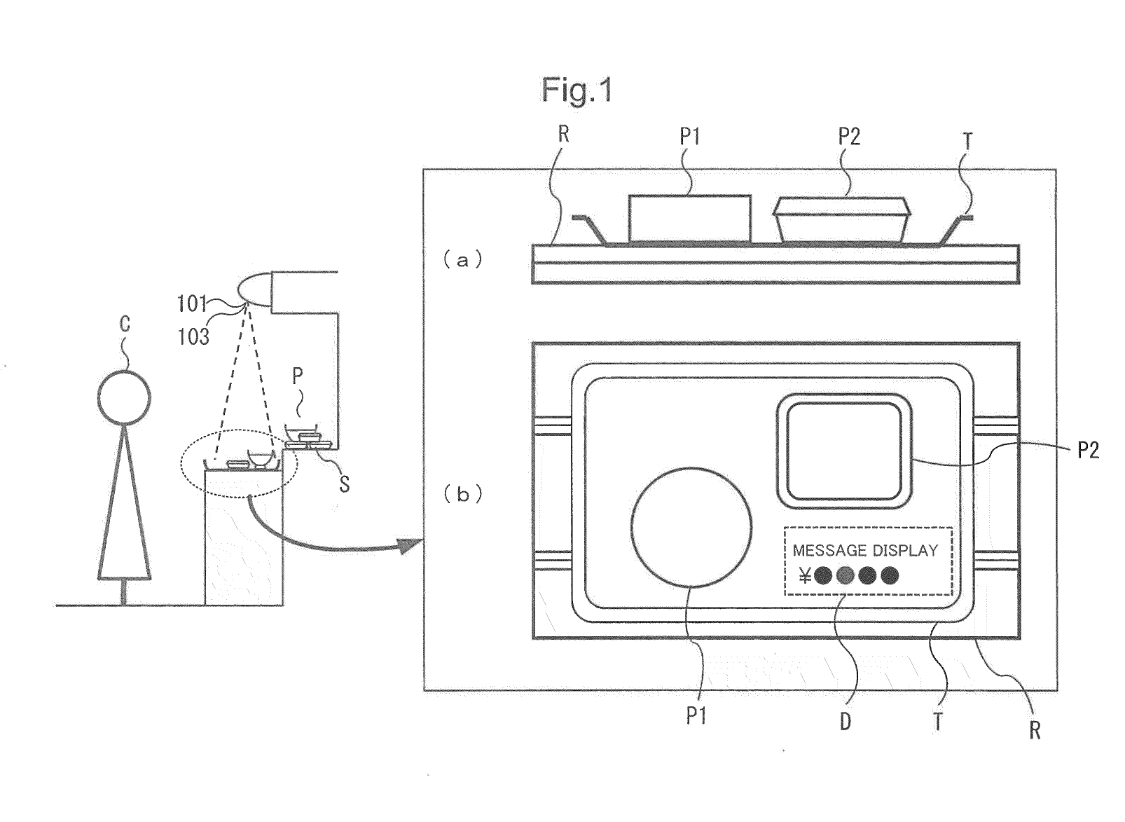

FIGS. 1 to 4 are diagrams for illustrating a first exemplary embodiment. This exemplary embodiment will be described with reference to the drawings in the following order. First, this exemplary embodiment will be outlined in “1.1”. Then, a functional configuration of a system will be described in “1.2”, a flow of processing is described in “1.3”, and an example of a hardware configuration capable of implementing the system will be described in “1.4”. Lastly, advantageous effects or the like of this exemplary embodiment will be described in “1.5”.

### (1.1 Overview)

A display system according to this exemplary embodiment will be outlined with reference to FIG. 1. The display system according to this exemplary embodiment is a system that is used in a self-service restaurant, for example, and a user C, who is a purchaser (customer), places a tray T on a tray rail R, takes a given product P from a showcase S and places the product P on the tray T. In this way, the purchaser, user C, proceeds to a checkout counter, not depicted, while sliding the tray T on the tray rail R, and then pays for the product P at the checkout counter.

While it is assumed in the following description that a user C purchases the product P, exemplary embodiments are not limited to this; for example, this exemplary embodiment can also be applied to a shop from which a product P is rented.

While this exemplary embodiment will be described on the assumption that a product P is placed on a tray T, the exemplary embodiment is not limited to this; a user C may place (set) a product P unpurchased in a container such as a shopping cart or basket.

In such a self-service purchasing system in general, the total amount to pay for products P placed on a tray T by a user C is visually counted by a cashier, or counted using RFID (Radio Frequency Identification) or the like, or counted by image processing with a camera installed at the checkout counter, and is displayed on a display near the checkout counter. In this method, the user C cannot know the total amount to pay until the user C reaches the checkout counter and therefore the user C does not prepare cash from his/her wallet until the user C reaches the checkout counter.

The time it takes for the user C to prepare cash to pay at the checkout counter is however the wait time for purchasers behind the user C in the checkout line. Since improving the skill of the cashier who handles the checkout does not cause to reduce the time it takes for the user C to prepare cash for payment, the checkout system may permit generating a long waiting line. In addition, when the line is too long, some customers may walk out rather than standing in the line, leading to lost sales opportunity. Moreover, since the user C prepares cash for payment while the cashier is waiting, the customer may feel nervousness, irritation, or embarrassment during the time, which can decrease customer satisfaction.

To address this problem, information D such as the total amount to pay for products, for example, is displayed on a tray or near a tray in this exemplary embodiment. Since this allows the user C to prepare cash for payment before reaching the checkout counter, the checkout process can be speed up. In addition, the total calories and nutrients of products or facility information such as seat availability and a tray return area can be displayed as information D, thereby customer satisfaction can be improved. Moreover, information, including advertisements, about products that are likely to be purchased together with the purchased products can be displayed as the information D to expect increasing the average customer spend.

For these purposes, the display system of this exemplary embodiment includes a display device 101 and a detection device 103. The detection device 103 includes the function of detecting the position of a tray T on a tray rail R, the positions of products P1 and P2 on the tray T, and the types of the products P1 and P2. The display device 101 is implemented by a projector, for example, and is capable of displaying given information D on the tray T.

With this arrangement, in the example in FIG. 1, the detection device 103 detects the position of the tray T and the types of products placed on the tray T and a display device which is not depicted in FIG. 1 calculates the total amount to pay for the products on the tray T and generates a message to be displayed on the tray T. Then the display device 101 displays the message in a region on the tray T where products P1 and P2 are not placed (an unoccupied region).

While it may appear that the detection range of the detection device 103 and the display range (the projection range) of the display device 101 are limited to a narrow range equivalent to the width of the tray rail R in FIG. 1, the detection and projection ranges can be expanded by arranging a plurality of devices so that the ranges overlap one another, even if the detection/display range of one device is small.

### (1.2 Functional Configuration of System)

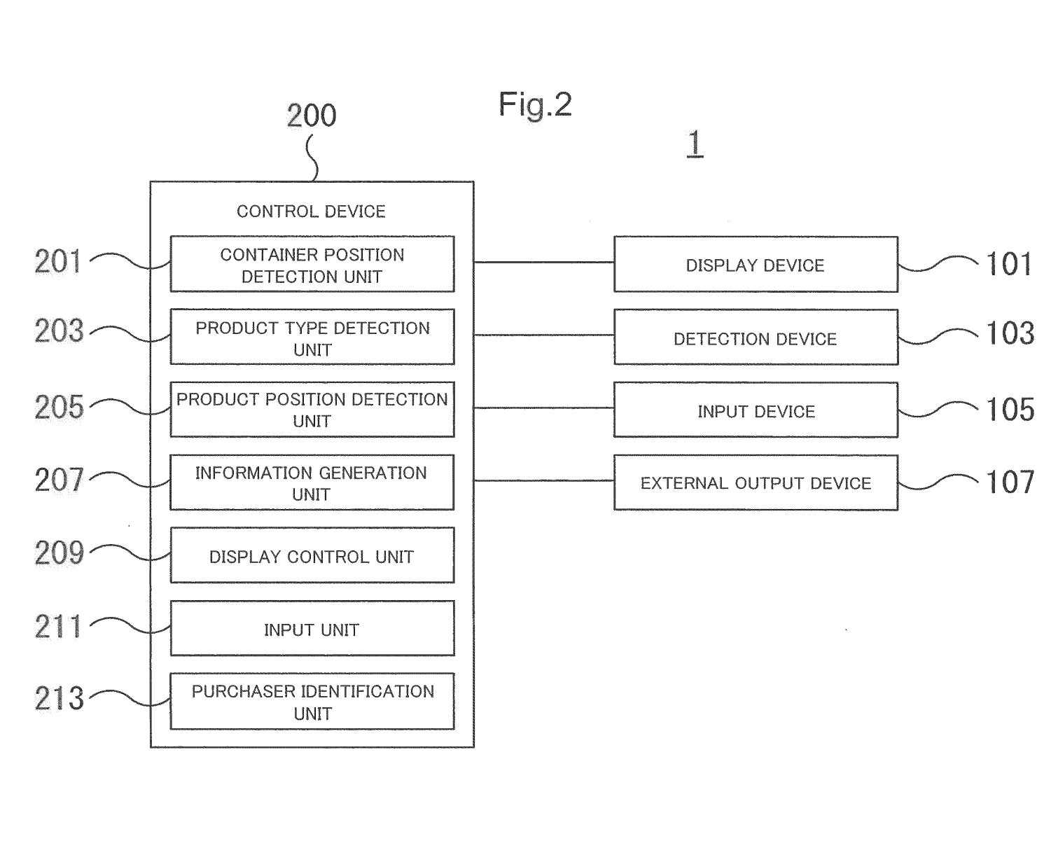

As illustrated in FIG. 2, the display system 1 according to this exemplary embodiment mainly includes the display device 101, the detection device 103, an input device 105, an external output device 107, and a control device 200.

As described above, the display device 101 displays on or near the tray T information about products P placed on the tray T. The information displayed may be information such as the total amount to pay for the products P, the total calorie of the products, information, including an advertisement, about products recommended based on the products P, seat availability information, the tableware stock location, and a message for asking for preparing small change.

An example of the display device 101 may be a projector as depicted in FIG. 1, for example, or a display embedded in the tray T (which may be implemented by an organic EL, a liquid-crystal display or the like). This exemplary embodiment is described on the assumption that the display device 101 is a projector.

The detection device 103 detects the position and orientation of a tray T, the types of products P on the tray T, the positions and orientations of the products P on the tray T (hereinafter sometimes simply referred to as the “position of a product P” to means both of the position and orientation of the product P) and the like as described previously. Since the positions and types of products P on a tray T and the position of the tray T change from moment to moment, the detection device 103 may be implemented by a device, for example a 2D or 3D camera or the like, that is capable of dynamically detecting the positions and the like.

The input device 105 is a device for accepting an input from user, for example, and may be implemented as a touch panel or a gesture recognition device or the like with a 2D or 3D camera, for example. A user C, who is a purchaser, can select display information D, select a payment method, or input the number of coins/bank bills used for payment to calculate predicted change beforehand, reserve a seat or reserve a dish that needs to be cooked, select and acquire a game for wait time, or select and acquire a coupon and the like. Note that the input device 105 may be omitted if an input from a user C is not accepted.

The external output device 107 is connected to an external device such as a POS terminal, for example, with a cable or wirelessly and includes the function of outputting a state of a user C, who is a purchaser, and other information. Note that if information does not need to be output to the outside, the external output device 107 is not necessary.

The control device 200 will be described next. The control device 200 is connected to the display device 101, the detection device 103, the input device 105, the external output device 107 and the like and performs various controls for suitably displaying information D on or near a tray T. The control device 200 includes a container position detection unit 201, a product type detection unit 203, a product position detection unit 205, an information generation unit 207, a display control unit 209, an input unit 211 and a purchaser identification unit 213.

The container position detection unit 201 uses a result of detection by the detection device 103 to detect the position and orientation of a tray T placed on the tray rail R at any time. There may be multiple methods for detecting the position of a tray T; for example recognition using 2D image processing or recognition using 3D shape measurement, for example, may be used.

The product type detection unit 203 uses a result of detection by the detection device 103 to identify the type of each product P placed on a tray T. There may be multiple methods for identifying the type of a product P; for example, matching with product shapes or product images that have been registered beforehand may be performed. Identifying the types of products P by the product type detection unit 203 enables the information generating unit 207 described below to calculate the total amount to pay for the products P placed on the tray T.

The product position detection unit 205 can use a result of detection by the detection device 103 to detect the position of a product P on a tray T. A method for detecting the position of a product P may be, for example, to compare a result of detection by the detection device 103 with the shape and an image of the tray T that have been registered beforehand to identify the position of the product P.

The information generation unit 207 generates display information D including information based on the type of a product P and other information that is to be displayed on or near a tray T. More specifically, information that can be included in the display information D may be the total amount to pay for the products placed on the tray T, the calorie of each of the product P on the tray T or the total calorie of the products P on the tray T, recommended products relating to the products P, for example. Additionally, the display information D may include information about available seats, a tableware stock location, advertisements, and a message asking for preparing small change.

The display control unit 209 controls the display device 101 to cause the display device 101 to display information D generated by the information generation unit 207 on or near the tray T. The display control unit 209 can determine the display position of display information D on the basis of the position and orientation (direction) of the tray T detected by the container position detection unit 201 and the position of a product P detected by the product position detection unit 205. More specifically, the display control unit 209 can cause the display device 101 to display information D parallel to the tray T in an unoccupied region on the tray T where no product P is placed as the example illustrated in FIG. 1, for example.

The input unit 211 includes the function of accepting a user input from the input device 105 and providing the input information to units in the control device 200. More specifically, the input unit 211 may accept from the input device 105 information concerning selection of display information D (which items of information is to be displayed), selection of a payment method, calculation of predicted change beforehand by an input of the number of coins/bank bills used for the payment, reservation of a seat or a dish that needs to be cooked, selection and acquisition of a game for wait time, or selection and acquisition of a coupon, for example. The display control unit 209 described above also can cause the display device 101 to display information D generated by the information generation unit 207 in accordance with these inputs. Note that the input unit 211 may be omitted if an input from a user C is not accepted.

The purchaser identification unit 213 includes the function of identifying a user C, who is a purchaser purchasing a product P on a tray T, as necessary. There may be multiple methods for identifying a user C such as a method in which an image or shape detected by the detection device 103 is compared with images or shapes of users C that have been registered beforehand to identify the user C or a method in which the user C him/herself inputs information about him/herself using the input device 105, for example. Note that the purchaser identification unit 213 may be omitted if processing that depends on users C is not performed.

### (1.3 Flow of Processing)

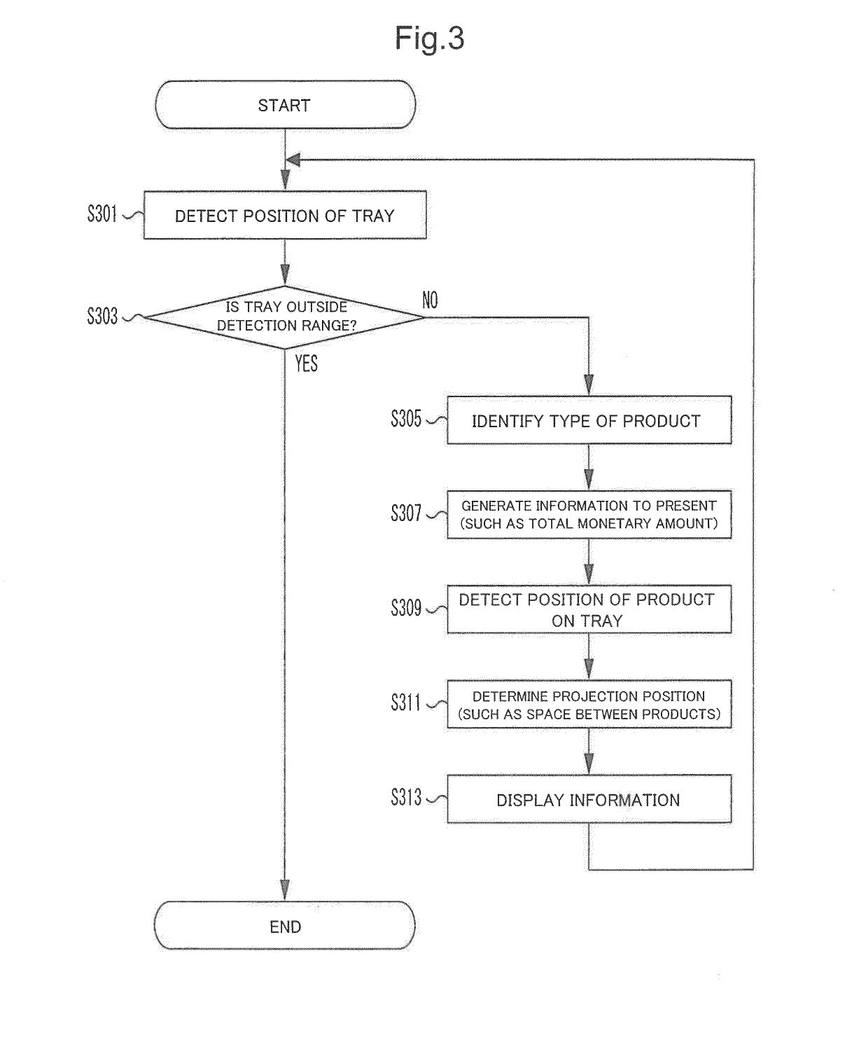

A flow of processing in the display system 1 will be described below with reference to FIG. 3. FIG. 3 is a flowchart illustrating a flow of processing performed by the control device 200 according to this exemplary embodiment.

Any of processing steps which will be described later may be arbitrarily reordered or may be executed in parallel and another step may be added between processing steps unless a contradiction arises in the processing. Furthermore, processing described in a single step for convenience may be divided into a plurality of steps and executed or processing described in a plurality of steps for convenience may be executed as a single step. This applies to second and other exemplary embodiments which will be described later.

First, the container position detection unit 201 detects the position of a tray T on the tray rail R (S301). When the tray T is outside the detection range as a result of the detection (Yes at S303), processing for the tray T ends. When the position of the tray T can be detected (No at S303), the product type detection unit 203 determines the type of a product on the detected tray T (S305). When a plurality of products P are placed on the tray T, the product type detection unit 203 identifies the types of all of the products P.

The information generation unit 207 generates information to be presented to the user C, i.e. display information D to be displayed on or near the tray T in accordance with the types of the products P on the tray T identified by the product type detection unit 203 (S307). More specifically, the information generation unit 207 can generate the display information D, for example, by calculating the total of the prices the products P placed on the tray T or by calculating the total calorie of the products.

The product position detection unit 205 detects the positions of the products P placed on the tray T (S309). On the basis of this, the display control unit 209 determines a display position on or near the tray T for displaying display information D (S311). More specifically, the display control unit 209 can choose an unoccupied region that is different from the regions where the products P are placed (also referred to as the product positions) on or near the tray T, for example, as the position in which the display information D is to be displayed.

As a result of the generation of the display information D and the determination of the display position of the display information D, the display control unit 209 displays the display information D in the position on or near the tray T that has been determined at S311 (S313). Then the flow returns to S301 and the processing is repeated.

Note that in this processing, the purchaser identification unit 213 may assume that the product type detection unit 203 acquires information personal information about the user C holding the tray T or information about an object other than products that is placed on the tray T, such as a coupon or a loyalty card, for example, in addition to the types of the products P placed on the tray T. In that case, the purchaser identification unit 213 can identify the user C holding the tray T from the personal information or the card information and the information generation unit 207 and the display control unit 209 can provide information customized to the user. For example, when coupon information can be acquired, the coupon information or the like can be reflected (for example, total amount to pay is reduced) in display information D indicating the total amount or the like. Furthermore, the average customer spend can be increased by performing a process such as providing additional purchase discount information on the basis of the coupon information.

Furthermore, when the product type detection unit 203 detects a coin/bank bill or the like for payment on the tray T, the information generation unit 207 can calculate the amount thereof and the display control unit 209 can display information such as change to be given back.

### (1.4 Hardware Configuration)

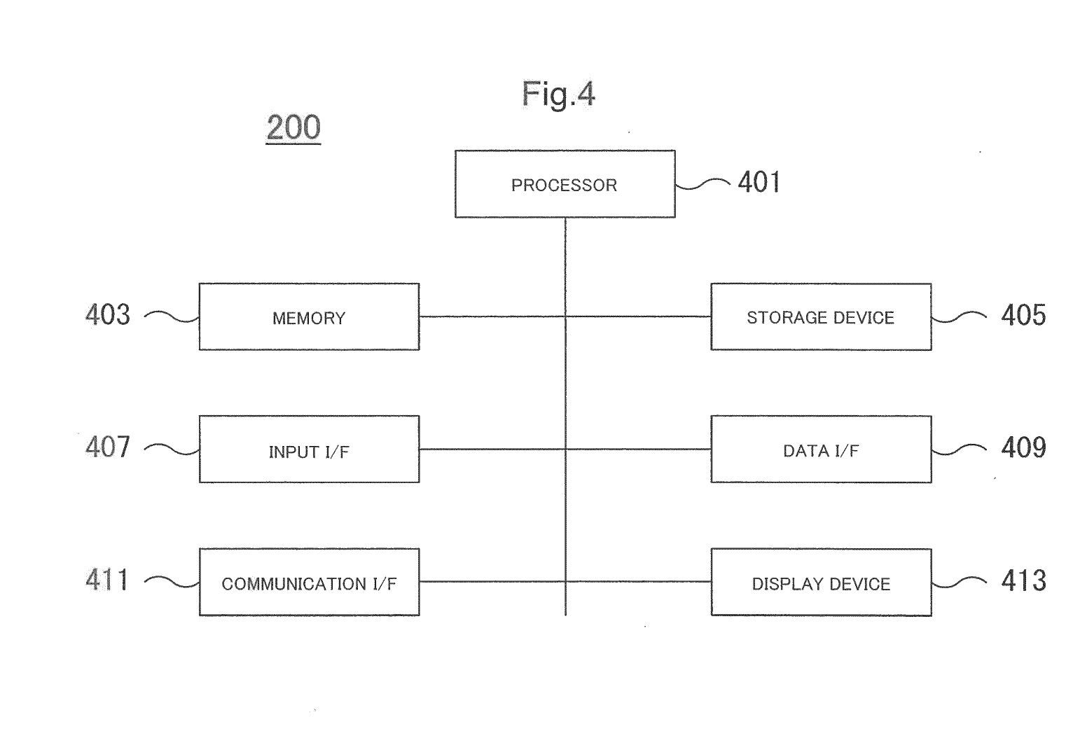

An exemplary hardware configuration of the above-described control device 200 implemented by a computer will be described below with reference to FIG. 4. Note that the functions of the control device 200 can also be implemented by a plurality of information processing devices.

As illustrated in FIG. 4, the control device 200 includes a processor 401, a memory 403, a storage device 405, an input interface (I/F) 407, a data I/F 409, a communication I/F 411 and a display device 413.

The processor 401 executes a program stored in the memory 403 to control various kinds of processing in the control device 200. For example, processing by the container position detection unit 201, the product type detection unit 203, the product position detection unit 205, the information generation unit 207, the display control unit 209, the input unit 211, and the purchaser identification unit 213 described with reference to FIG. 2 can be implemented as programs that is temporarily stored in the memory 403 and then run on the processor 401.

The memory 403 is a storage medium such as a RAM (Random Access Memory), for example. The memory 403 temporarily stores program codes of a program to be executed by the processor 401 and data required during execution of the program. For example, a stack area, which is required during execution of a program, is provided in a storage region in the memory 403.

The storage device 405 is a nonvolatile storage device such as a hard disk or a flash memory. The storage device 405 stores an operating system, various programs to implement the container position detection unit 201, the product type detection unit 203, the product position detection unit 205, the information generation unit 207, the display control unit 209, the input unit 211 and the purchaser identification unit 213, and various data used in the programs and other programs. The programs and data stored in the storage deice 405 are loaded into the memory 403 as needed and are referred to by the processor 401.

The input I/F 407 is a device for accepting inputs from users. The input device 105 described with reference to FIG. 2 can be implemented by the input I/F 407. Examples of the input I/F 407 include a keyboard, a mouse, a touch panel, and various types of sensors. The input I/F 407 may be connected to the control device 200 through an interface such as a USB (Universal Serial Bus).

The data I/F 409 is a device for inputting data from outside the control device 200. Examples of the data I/F 409 include drive devices for reading data stored in various storage devices. The data I/F 409 may be provided external to the control device 200. In that case, the data I/F 409 is connected to the control device 200 through an interface such as a USB.

The communication I/F 411 is a device for performing wired or wireless data communication with devices external to the control device 200, for example a POS terminal. The external output device 107 described with reference to FIG. 2 can be implemented by the communication I/F 411. The communication I/F 411 may be provided external to the control device 200. In that case, the communication I/F 411 is connected to the control device 200 through an interface such as a USB, for example.

The display device 413 is a device for displaying various kinds of information. The display device 101 described with reference to FIG. 2 can be implemented by the display device 413. Examples of the display device 413 include a projector, a liquid-crystal display, and an organic EL (Electro-luminescence) display, for example. The display device 101 may be provided external to the control device 200 and, for example, the display device 413, which may be a liquid-crystal display or an organic EL, for example, may be integrated into a tray T, for example.

### (1.5 Advantageous Effects of Present Exemplary Embodiment)

Because information, such as the total amount to pay, that depends on a product P is displayed on or near a tray T on which a user C has placed the product P at any time before the user C reaches the checkout counter in the display system 1 according to this exemplary embodiment as described above, the display system 1 allows a user C to prepare for payment of the amount before the user C reaches the checkout counter. This can speed up the payment transaction. Since information such as the total calorie, nutrients, and facility information such as seat availability and a tableware location can be additionally provide to users, congestion after payment can be reduced and customer satisfaction can be increased. Furthermore, information about recommended products and other advertisements can be projected to increase average customer spend.

### 2 Second Exemplary Embodiment

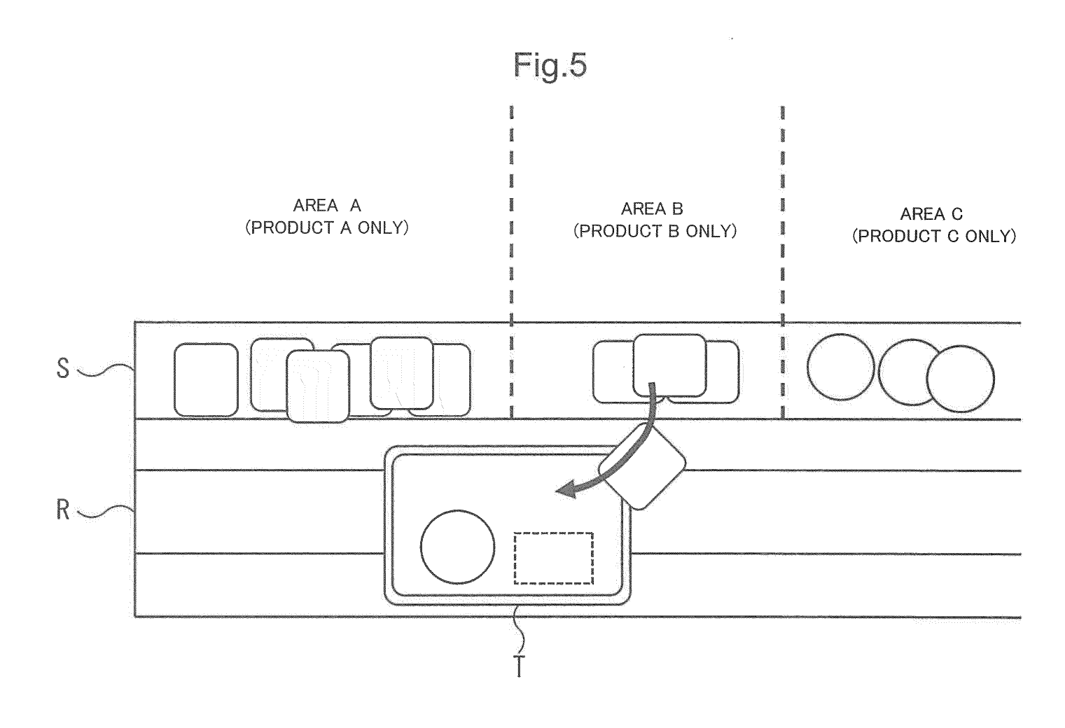

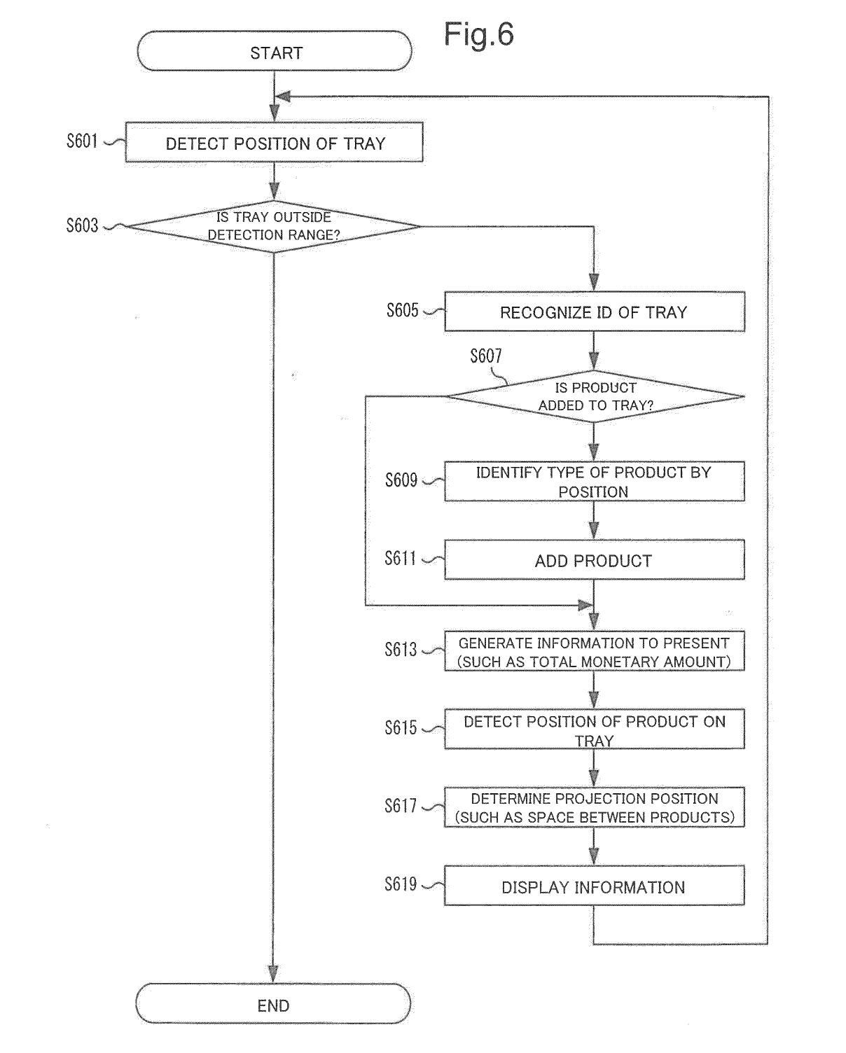

A second exemplary embodiment will be described below with reference to FIGS. 5 and 6. In the following description, the same reference numerals are given to the same or similar components as those of the first exemplary embodiment and description thereof will be omitted. Description of operations and effects similar to those of the first exemplary embodiment will also be omitted.

### (2.1 Overview)

The second exemplary embodiment significantly differs from the first exemplary embodiment in the method for identifying products P on a tray T. The method for identifying products P on a tray T in this exemplary embodiment will be described below with reference to FIG. 5.

Even the products P are the same product such as an item of food, for example a side-dish or bread, usually slightly varies in shape. It may be difficult to identify such a product P by 2D image processing or 3D shape measurement as in the first exemplary embodiment. An item of food may be placed on another item of food, such as a topping on a bowl of rice or noodles, without using a dish with an embedded RFID tag and in such a case, the same problem is likely to arise.

To address this problem, each type of product P is placed in a predetermined position in a showcase S and the type of a product P is detected by detecting the time at which a user C, who is a customer, has picked up the product P and the position in the showcase S from which the user C has picked up the product P in this exemplary embodiment. In the example in FIG. 5, when a product has been picked up from area A, it can be detected that product A has been placed on a tray T; when a product has been picked up from area B, it can be determined that product B has been placed on a tray T; and when a product has been picked up from area C, it can be determined that product C has been placed on a tray T. Note that showcases S may be stacked on top of another.

Which tray T the product P has been placed on can be detected by assigning unique IDs (identifiers) to the trays T and managing the IDs. The ID may be a number printed on the tray T beforehand or an ID such as an embedded RFID tag that can explicitly identify the tray T or may be an ID virtually determined in accordance with a product acquisition history on the tray T.

Whether or not a product P has been transferred to the tray T can be detected by a product type detection unit 203 on the basis of a change in the mass of the showcase S, a change in an image of the showcase S with time, the number of times a hand entered in the showcase S or other factors detected by a detection device 103.

The outline of the functional configuration of the system is similar to that of the first exemplary embodiment described with reference to FIG. 2 and therefore description thereof will be omitted.

### (2.2 Flow of Processing)

A flow of processing in the display system 1 according to this exemplary embodiment will be described below with reference to FIG. 6. FIG. 6 is a flowchart illustrating a flow of processing in the display system 1 according to this exemplary embodiment.

First, a container position detection unit 201 detects the position of a tray T (S601). When the tray T is outside a detection range (Yes at S603) as a result of the detection, processing for the tray T ends. When the position of the tray T can be detected (No at S603), the container position detection unit 201 identifies an identifier (ID) of the tray T (S605). Trays T may be identified by assigning IDs to the trays T by printing an ID on each tray T, or embedding an RFID tag in each tray T beforehand, or dynamically assigning an ID to each of trays newly detected on the tray rail R as described above.

Then the product type detection unit 203 uses the function of the detection device 103 to determine whether or not a product has been added on the tray T (S607). The determination may be made on the basis of a change in the mass of the showcase S, change in an image of the showcase S, or whether or not a hand has entered a display location in the showcase S as described above. When a product has been added on the tray (Yes at S607), the product type detection unit 203 identifies the type of the product P on the tray T. The identification may be made by identifying the region in the showcase S in which the mass has changed, or identifying the position in which the image of the showcase S has changed, or identifying the position in which a hand has entered a display location in the showcase S. When the type of the product P can be identified, the information generation unit 207 determines that a product P of the type has been added on the tray T and performs step S613 and the subsequent processing.

The information generation unit 207 generates information to be presented to the user C, i.e. display information D to be displayed on or near the tray T in accordance with type of the product P on the tray T that has been identified by the product type detection unit 203 (S613). More specifically, the information generation unit 207 can generates the display information D, for example, by calculating the total price for products P placed on the tray T or by calculating total calorie of products P on the tray T.

The product position detection unit 205 detects the position of a product P placed on the tray T (S615). This enables the display control unit 209 to choose an unoccupied region that is different from the region in which the product P is placed as a position in which the display information D is to be displayed within a region on or near the tray T (S617).

As a result of the generation of the display information D and the determination of the display position, the display control unit 209 displays the display information D in the position on or near the tray T that has been determined at S617 (S619). Then the flow returns to S601 and the processing is repeated.

### (2.3 Advantageous Effects of Present Exemplary Embodiment)

As has been described above, like the display system according to the first exemplary embodiment, the display system 1 according to this exemplary embodiment displays information, such as the total amount to pay, that depends on a product P on or near a tray T on which a user C has placed the product P at any time before the user C reaches the checkout counter, and thus allows a user C to prepare for payment of the amount before the user C reaches the checkout counter. This can speed up the payment transaction. Since information such as the total calorie, nutrients, and facility information such as seat availability and a tableware location can be additionally provide to users, it can be expected to reduce congestion after payment and to increase customer satisfaction. Furthermore, information about recommended products and other advertisements can be projected to increase average customer spend.

In addition, since the type of a product P is identified on the basis of the position in which the product P has been picked up in this exemplary embodiment, the type of the product P can be properly identified even when the product P varies in shape or when the product P is a topping on another product, for example.

### 3 Third Exemplary Embodiment

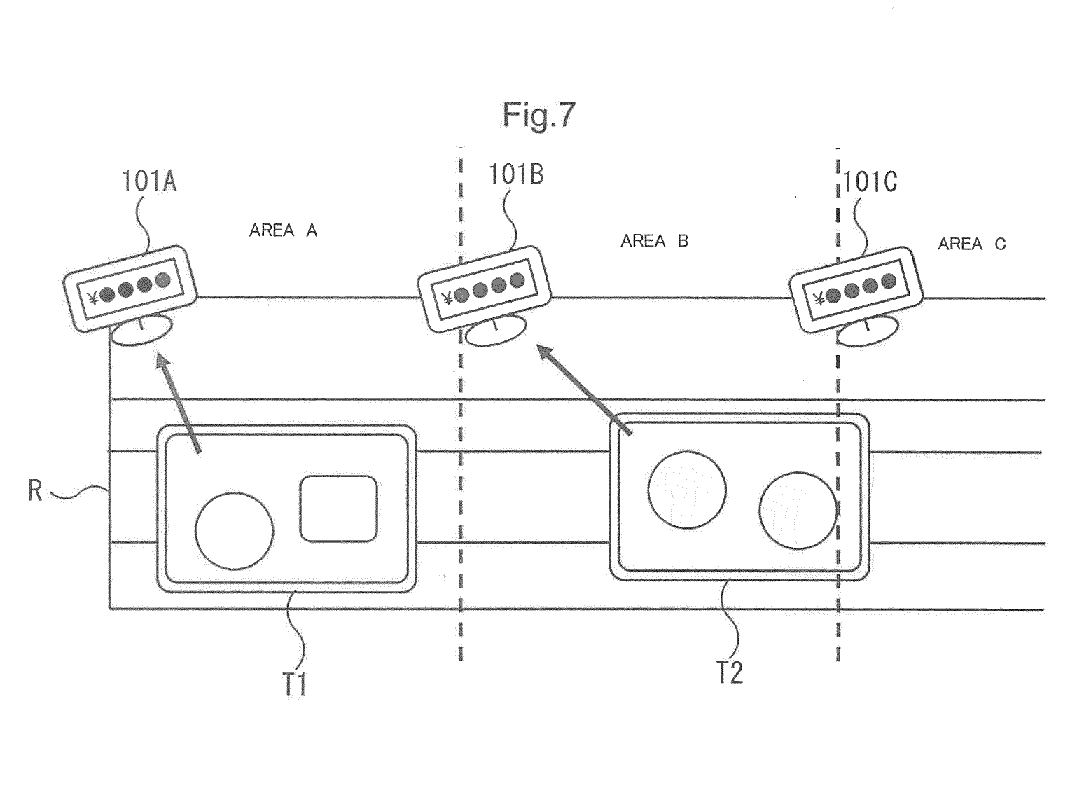

A third exemplary embodiment will be described below with reference to FIG. 7. In the following description, the same reference numerals are given to the same or similar components as those of the first exemplary embodiment and description thereof will be omitted. Description of operations and effects similar to those of the first exemplary embodiment will also be omitted.

The third exemplary embodiment significantly differs from the first and second exemplary embodiments in the method of displaying display information D. A method of displaying display information D in this exemplary embodiment will be described with reference to FIG. 7.

A display system 1 according to this exemplary embodiment includes a plurality of display devices 101 (three display devices 101A, 101B, and 101C in the example in FIG. 7). A display control unit 209 displays display information D on any of the display devices 101A to 101C. More specifically, display information D for a tray T1 in area A is displayed on the display device 101A and display information D for a tray T2 in area B is displayed on the display device 101B. As the tray T moves, the display information D is displayed on a different display device 101.

The outline of the functional configuration of the system and the flow of processing are similar to those of the first exemplary embodiment described with reference to FIGS. 2 and 3 and therefore description thereof will be omitted.

Like the display systems of the first and second exemplary embodiments, the display system 1 according to this exemplary embodiment displays information, such as the total amount to pay, that depends on a product P near a tray T on which a user C has placed the product P at any time before the user C reaches the checkout counter, and thus allows a user C to prepare for payment of the amount before the user C reaches the checkout counter. This can speed up the payment transaction. Since information such as the total calorie, nutrients, and facility information such as seat availability and a tableware location can be additionally provide to users, it can be expected to reduce congestion after payment and to increase customer satisfaction. Furthermore, information about recommended products and other advertisements can be projected to increase average customer spend.

Note that when display information D is displayed on the display of a display device 101, there may be other methods of displaying display information D in addition to the method of switching from one display device 101 to another among the plurality different display devices 101 as described above. For example, when a user C has an information terminal such as a smartphone, the display control unit 209 may transmit an image or data to the display device 101 to cause the display device 101 to display the image or data.

### 4 Fourth Exemplary Embodiment

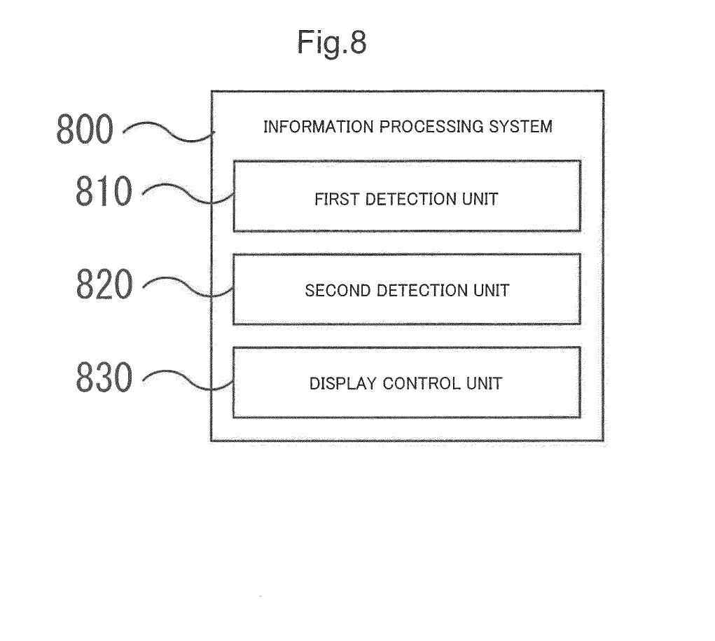

A fourth exemplary embodiment will be described below with reference to FIG. 8. FIG. 8 is a block diagram illustrating a functional configuration of an information processing system 800. As illustrated in FIG. 8, the information processing system 800 includes a first detection unit 810, a second detection unit 820 and a display control unit 830.

The first detection unit 810 detects a container position which is the position of a container in which an object to be measured, for example a product or the like is placed. The second detection unit 820 detects the type of the object to be measured that is placed in the container.

The display control unit 830 displays information based on the type of a detected object to be measured in or near the position of a container.

The information processing system 800 according to the present exemplary embodiment thus implemented enables information to be suitably provided to customers.

### 5 Note 1

The components of the exemplary embodiments described above may be combined or some of the components may be replaced. The configurations of the present invention are not limited to the exemplary embodiments described above; various modifications may be made to the exemplary embodiments without departing from the spirit of the present invention.

In particular, in addition to the methods described above, there may be various methods for detecting the types of container of a tray T, the positions of a tray T and a product P, for detecting the type of a product P, and for providing display information D by the display control unit 209, and contents of the display information D. An example will be discussed below in which the container in which a user C places products P is a shopping cart equipped with a tablet, instead of a tray T. In this case, a system can be contemplated in which a product type detection unit 203 identifies the position from which a product P has been taken out on the basis of a position detected by a detection device 103 which is implemented as a pressure sensor on the floor and identifies the type of the product P on the basis of information indicting the change in the weight of the cart and the position from which the product P has been taken out, and display information D generated as a result is displayed on a display mounted on the shopping cart.

### 6 Fifth Exemplary Embodiment

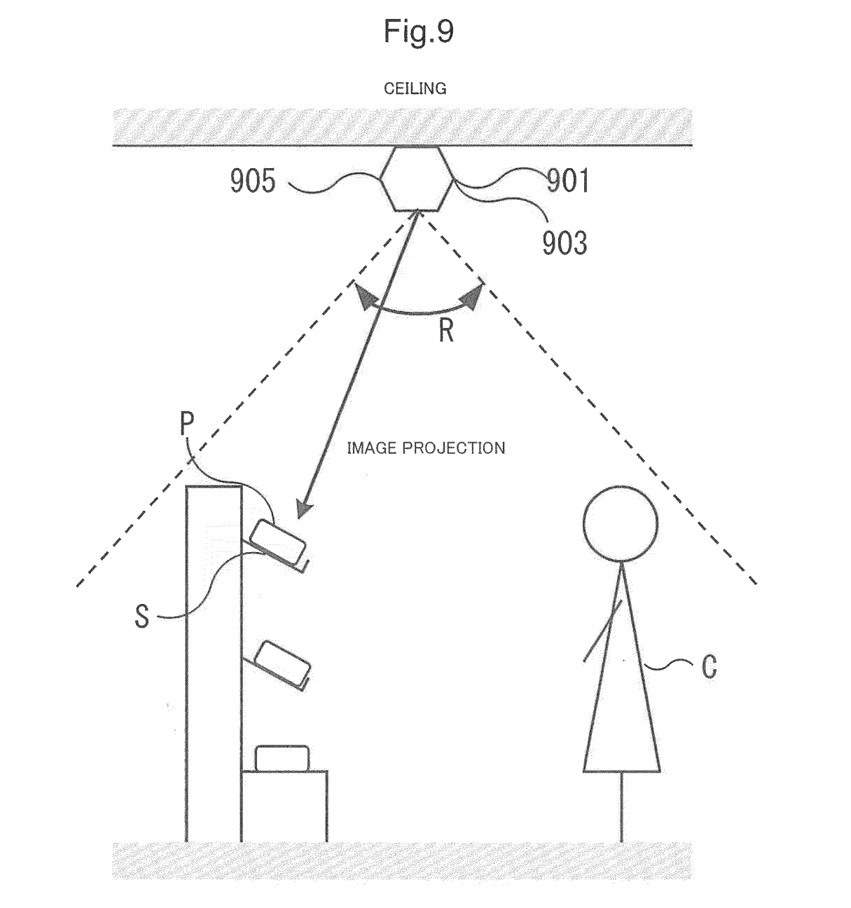

FIGS. 9 to 12 are diagrams for illustrating a fifth exemplary embodiment. This exemplary embodiment will be described with reference to the drawings in the following order. First, this exemplary embodiment will be outlined in “6.1”. Then, a functional configuration of a system will be described in “6.2”, a flow of processing is described in “6.3”, and an example of a hardware configuration capable of implementing the system will be described in “6.4”. Lastly, advantageous effects of this exemplary embodiment will be described in “6.5”.

### (6.1 Overview)

A display system according to this exemplary embodiment will be outlined with reference to FIG. 9. The display system according to this exemplary embodiment implements digital signage which displays information about products or services in a store, for example.

In a digital signage system in which a display or the like is installed near a product or a service (hereinafter a product and service will be sometimes collectively referred to as a “product”) and information about the product or the like is displayed on the display, usually a screen is for displaying product information is located apart from the product. In such a system, when digital signage is used to make an announcement about features or the like of a product to customers (digital signage viewers/purchasers, hereinafter also referred to as “users”), attention of the customers needs to be directed to contents of information on a screen on which product information is displayed, rather than the product itself. In other words, since the attention of customers is directed to the screen, the attention of the customers can drift away from the product itself.

In the display system according to this exemplary embodiment, an image is projected onto or near a surface of a product P with a projecting device 901, which is a projector, for example, rather than on a display provided apart from the product (object) when a user C approaches the product P, as illustrated in FIG. 9. When the user C, who is a customer, makes an action such as picking up the product, the projected image is dynamically moved as the product moves with the action. When subsequently the user C has left the product P, the image projection is stopped.

This implementation enables the attention of users C to be directly attracted to the product P itself and consequently can increase sales. Furthermore, the flexibility of the layout of images and the layout of products can be increased because a dedicated screen does not need to be provided, unlike digital signage using a conventional display such as an LCD (Liquid Crystal Display).

To implement such a display system, the display system according to the exemplary embodiment illustrated in FIG. 9 includes a projection device 901, a detection device 903 and a drive device 905.

The detection device 903 in the system constantly (dynamically) detects the positions and orientations of products P placed in a showcase S and the positions and motions of users C in a detection range R. The projection device 901 includes the function of projecting (displaying) an image onto a surface of a product P or onto a location near a product P. The drive device 905 is a device for changing the direction of projection of the projection device 901. The drive device 905 can drive the projection device 901 to change the position of projection as the position or orientation of the product P changes.

While only one projection device 901, one detection device 903 and one drive device 905 are illustrated and are implemented as a single collective device in the example in FIG. 9, the devices are not limited to this implementation. For example, a plurality of collective devices each including a projection device 901, a detection device 903 and a drive device 905 may be provided or a projection device 901, a detection device 903 and a drive device 905 may be installed separately from one another. In particular, a plurality of collective devices each including a projection device 901 and a drive device 905 may be installed whereas only one detection device 903 or fewer detection devices 903 than the collective devices may be installed.

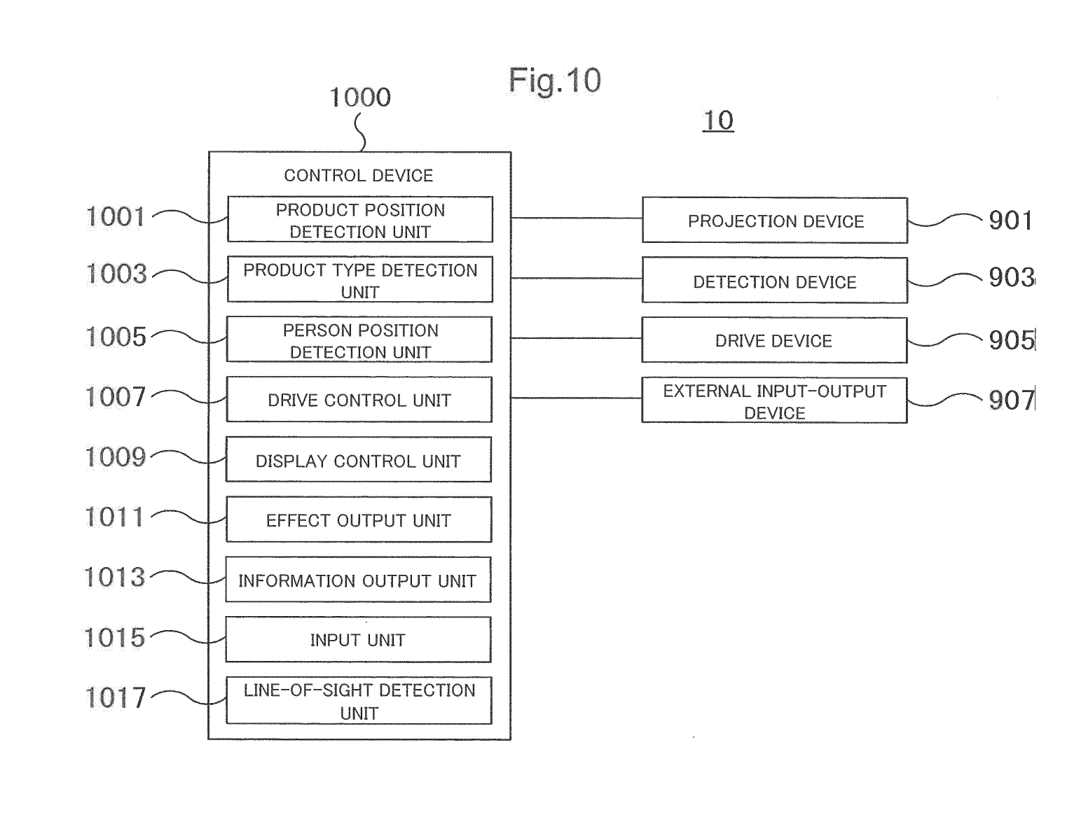

If a plurality of projection devices 901, detection devices 903 and drive devices are provided, a control device 1000 (depicted in FIG. 10) that controls the devices may control the projection devices 901, the detection devices 903 and the drive devices 905 so that the devices operate in conjunction with one another. When a drive device 905 physically changes the position and direction of projection by a projection device 901, usually an image can be projected onto only one location at a time. Therefore, in order that an image can be projected onto a plurality of locations, the projection devices 901 and the drive devices 905 may be installed so that projection ranges coincide with each other or overlap each other.

### (6.2 Functional Configuration of System)

As illustrated in FIG. 10, a display system 10 according to this exemplary embodiment mainly includes a projection device 901, a detection device 903, a drive device 905, an external input-output device 907, and a control device 1000.

The projection device 901 is driven by the drive device 905 as described above to project an image relating to product information (including a video) onto a surface of a product P or onto a location near the product P. Information displayed may be information about the product P itself or may be information (recommendation) about a product that is often purchased with the product P. An example of the projection device 901 is a projector.

The detection device 903 detects the positions, directions and motions of products P and users C. This enables an image relating to product information to be projected onto a product P monitored or onto a location near the product P when a user C enters a predetermined range from the product P, for example. The detection device 903 may include the function of detecting the line of sight of a user C. In that case, the projection device 901 can be implemented to project an image when the user C is in the detection range R of the detection device 903 and faces toward the product P.

The detection device 903 can be implemented by a 2D or 3D camera, for example. Such a detection device 903 may detect the position of a user C from a 2D image or 3D measurement data, for example, or may detect the position of a user C by using position recognition in conjunction with human shape recognition. The detection device 903 may detect the position of a product P by detecting a predetermined position or may use image recognition (including 2D and 3D image recognition), for example.

Under the control of the control device 1000, the drive device 905 directs the projection device 901 toward the position and direction in which an image is to be projected by the projection device 901. More specifically, the drive device 905 directs the projection device 901 toward a surface of a product P or toward a location near the product P and causes the projection by the projection device 901 to follow the product P as the product P is moved by a user C holding the product P. The drive device 905 may change the projection direction and projection position by physically changing the orientation of the projection device 901 or by changing an optical system (such as a lens or a light valve) inside the projection device 901. Alternatively, the projection direction may be changed with a mirror attached to the front of the projection device 901. Alternatively, when the projection range of the projection device 901 is wide, the drive device 905 may control the projection device 901 so that an image or video for only a portion of entire projection range is generated and the position of the image or video is changed.

The external input-output device 907 is connected by wire or wirelessly to at least one of a light, a speaker, a display, a checkout system, an in-store monitoring system, a business terminal, a personal terminal, a content control device, an advertisement distribution device, an audio distribution device, a data input device and a surveillance camera and acts as an interface for inputting and outputting (communicating) information as needed. More specifically, the external input-output device 907 can issue various control commands to a light, a speaker, a display and the like to add an effect such as switching of audio and lighting to display of information by the projection device 901 under the control of the control device 1000. Furthermore, the external input-output device 907 can output various kinds of data to the checkout system, the in-store monitoring system, the business terminal, the personal terminal and the like to made information such as the position and purchasing activities of a user C available to these devices. Furthermore, when the external input-output device 907 accepts inputs from any of the content control device, the advertisement distribution device, the audio distribution device, the business terminal, the personal terminal, the data input device, the in-store monitoring system, the checkout system and the surveillance camera, the external input-output device 907 can cause the projection device 901 to project (display) accepted input information or to output the input information to the light or the speaker mentioned above, for example.

Note that if the input and output functions are not used, the display device 10 does not necessarily need to include the external input-output device 907.

The control device 1000 will be described next. The control device 1000 is connected to the projection device 901, the detection device 903, the drive device 905, the external input-output device 907 and other devices and includes the function of controlling each of these devices. The control device 1000 includes a product position detection unit 1001, a product type detection unit 1003, a person position detection unit 1005, a drive control unit 1007, a display control unit 1009, an effect output unit 1011, an information output unit 1013, an input unit 1015 and a line-of-sight detection unit 1017.

The production position detection unit 1001 can detect whether or not there is a product P in the detection range R and, when there is a product P, detect the position and orientation of the product by using 2D images or 3D measurement data, which are result of detection by the detection device 903. A product P may be detected, for example, by comparing images or shapes of products P which have been registered beforehand with a 2D image or 3D measurement data from the detection device 903 or by detecting a change in shape from a state in which the product P is not placed.

The product type detection unit 1003 uses a result of detection by the detection device 903 to identify the type of a product P. The product type detection unit 1003 may identify the type of a product P on the basis of the degree of matching between a 2D image, which is a result of detection by the detection device 903, and a product image registered for each product beforehand, for example. Alternatively, the product type detection unit 1003 may identify the type of a product P on the basis of the position of the product P in the showcase S that has been identified by the product position detection unit 1001. Identification of the type of a product P by the product type identification unit 1003 allows the display control unit 1009 to cause the projection device 901 to project information (image) in accordance with the type of the product P.

The person position detection unit 1005 identifies the position of a user C by using a 2D image or 3D measurement data which is a result of detection by the detection device 903. The position of a user C may be identified by using a result of detection by an external input-output device 907 that is a sensor that detects infrared radiation from a person who has entered a predetermined range, for example.

The drive control unit 1007 controls the drive device 905 to change the position and direction of projection of an image by the projection device 901. The position of projection by the projection device 901 may be switched between a location on the surface of a product P and a location near the product P in accordance with the type of the product P, for example. More specifically, the drive control unit 1007 may control the drive device 905 so that if a product P has a simple package, an image is projected onto a surface of the product P and otherwise, an image is projected onto a surface of the showcase S near the product P. Furthermore, as noted above, when the position or orientation of a product P has been changed by a user C picking up the product P, the drive control unit 1007 controls the drive device 905 so that the position and orientation of a projected image changes accordingly. The drive control unit 1007 may perform control to change the position and direction of the projected image with the movement of the product P when the image is projected on the surface of the product P or not to change the projected image with the movement of the product P when the image is projected on the showcase S near the product P, depending on the type of the product P.

The display control unit 1009 controls the projection device 901 to cause the projection device 901 to project an image to be displayed on a surface of a product P or a location near the product P. Depending on the result of human detection by the person position detection unit 1005, the display control unit 1009 performs control to cause the projection device 901 to project information when a user C is within a predetermined range from the product P or control to cause the projection device 901 to stop projection when a user C is not within the predetermined range. Alternatively, depending on the result of detection of the line of sight of a user C by the line-of-sight detection unit 1017, the display control unit 1009 may cause to project an image when the product P is within the range of view field of the user C or cause to stop projection of an image when the product P has moved out of the range of view field of the user C. Alternatively, information about a product P may be projected in the range of view field of a user C when the product P is not within the range of view field of the user C. Alternatively, the display control unit 1009 may cause the projection device 901 to stop projection when a condition is met, such as a predetermined time has elapsed since the start of display.

The information projected as an image by causing the projection device 901 to project the image by the display control unit 1009 may be an advertisement relating to a product P, the price or a reduced price for the product P, how to use the product P, the stock of the product P, or an introduction to a recommended product that is often purchased together with the product P. These items of information may be displayed in combination. In addition to causing direct information to be displayed, the display control unit 1009 may perform control such as control to shine a spotlight on the product P, projecting flashing or moving light onto the product P, or projecting information indicating the position of the product P.

The information projected as an image by causing the projection device 901 to project the image by the display control unit 1009 may be provided beforehand or input from a source such as a content control device, an advertisement distribution device, an audio distribution device, a business terminal, a personal terminal, a data input device, an in-store monitoring system, or a checkout system which are connected to the external input-output device 907. Additionally, the information to be projected by the projection device 901 may be caused to vary depending on customer information about a user C (such as sex and age, for example), for example, acquired by the input unit 1015 from a surveillance camera or the like, not depicted.

Furthermore, the product position detection unit 1001 may detect the orientation or color of a surface of a product P an image of which is to be projected by the projection device 901 and the display control unit 1009 may correct the image to be projected in accordance with the result of the detection. The correction may be color correction (which may be correction such as darkening blue, avoiding using blue, or color reversal when the region on which an image is to be projected is blue) and correction of distortion of the shape of the image projected on a projection surface that is not perpendicular to the optical axis of projection (including correction such as the so-called keystone correction), for example.

The effect output unit 1011 uses devices such as a light, a speaker, and a display which are connected to the external input-output device 907 to add effects relating to a product P for users C. Effects added by the effect output unit 1011 may be, for example, output of sound through a speaker or flashing or moving light to highlight a product P as descried with respect to the display control unit 1009. Adding such effects can enhance impression on users C, leading to an increase in the advertising effectiveness. If such effects are not necessary, the control device 1000 does not necessarily need to include the effect output unit 1011.

The information output unit 1013 includes the function of outputting information to various devices such as a checkout system, an in-store monitoring system, business terminals and personal terminals through the external output input-output device 907. Output information may be information about positions and directions relating to products P and users C, for example.

The input unit 1015 accepts various kinds of data received at the external input-output device 907 from various devices such as a content control device, an advertisement distribution device, an audio distribution device, a business terminal, a personal terminal, a data input device, an in-store monitoring system, a checkout system and a surveillance camera, for example, and provides the input information to units of the control device 1000. Input information accepted may be information to be projected by the projection device 901 and control commands for controlling the units of the control device 1000 or the like, for example.

If the display system 1 does not have the input/output function, the control device 1000 does not necessarily need to include the information output unit 1013 and the input unit 1015.

The line-of-sight detection unit 1017 detects the orientation or the line of sight of a user C by using the detection device 903, as needed. When the line-of-sight detection unit 1017 can estimate whether or not a product P is in the range of view field of the user C, the display control unit 1009 can control the projection device 901 to project information only when the product P is in the range of view field of the user C. Note that such control is not performed, the line-of-site detection unit 1017 is not required.

### (6.3 Flow of Processing)

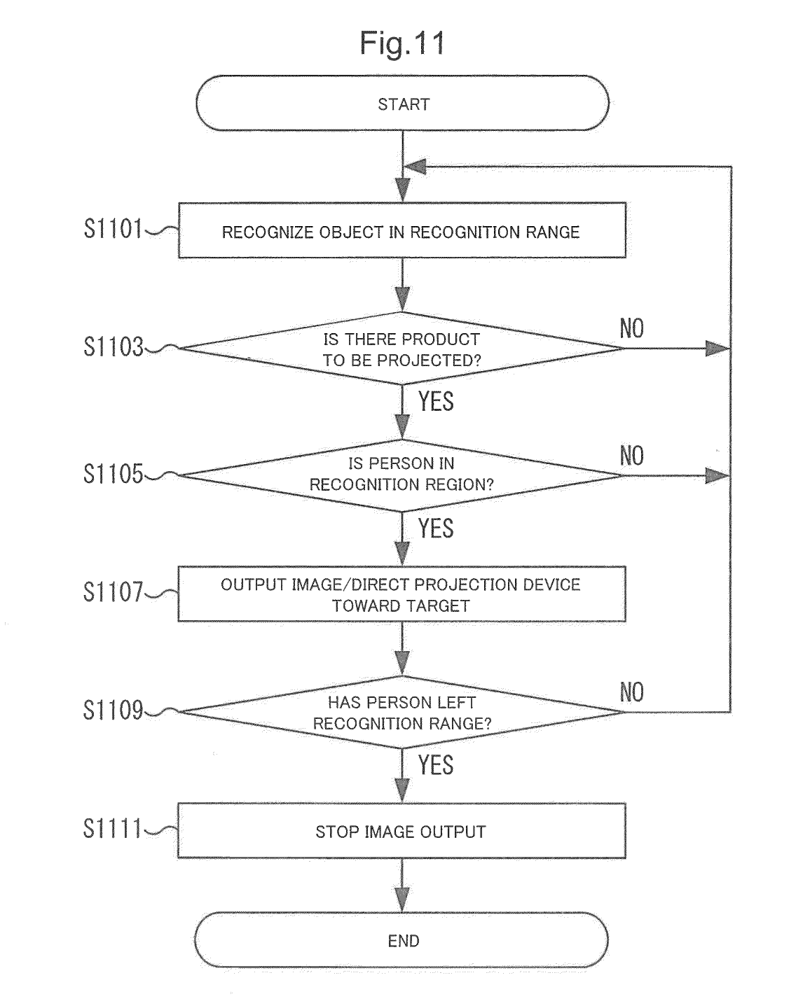

A flow of processing in the display system 10 will be described below with reference to FIG. 11. FIG. 11 is a flowchart illustrating a flow of processing by the control device 1000 according to this exemplary embodiment.

Any of processing steps which will be described later may be arbitrarily reordered or may be executed in parallel and another step may be added between processing steps unless a contradiction arises in the processing. Furthermore, processing described in a single step for convenience may be divided into a plurality of steps and executed or processing described in a plurality of steps may be executed as a single step. This applies to sixth and other exemplary embodiments which will be described later.

First, the product position detection unit 1001 and the person position detection unit 1005 recognize an object in the detection range R on the basis of a result of detection by the detection device 903 (S1101). When a product P is not in the detection range R (No at S1103) or when no user C is in the detection range R (No at S1105) from the detection result, the flow returns to S1101 and the processing is repeated until both of a product P and a user C are detected.

When the product detection unit 1001 has detected a product P and the person position detection unit 1005 has detected a user C (Yes at S1105), the display control unit 1009 causes the projection device 901 to project an image relating to the product P and the drive control unit 1007 controls the drive device 905 to direct projection by the projection device 901 toward a surface of the product P or a location near the product P, for example on the showcase S (S1107). At this time, the product type detection unit 1003 may detects the type of the product P and the display control unit 1009 may cause the projection device 901 to project a different image in accordance with the result of the detection.

Then, processing S1101-S1109 is repeated until the user C leaves the detection range R of the detection device 903 (No at S1109) and, when the product P has moved, the drive control unit 1007 can cause the projection by the projection device 901 to follow the product P accordingly.

When the user C leaves the detection range R of the detection device 903 (Yes at S1109), the display control unit 1009 causes the projection device 901 to stop projecting the image (S1111).

### (6.4 Hardware Configuration)

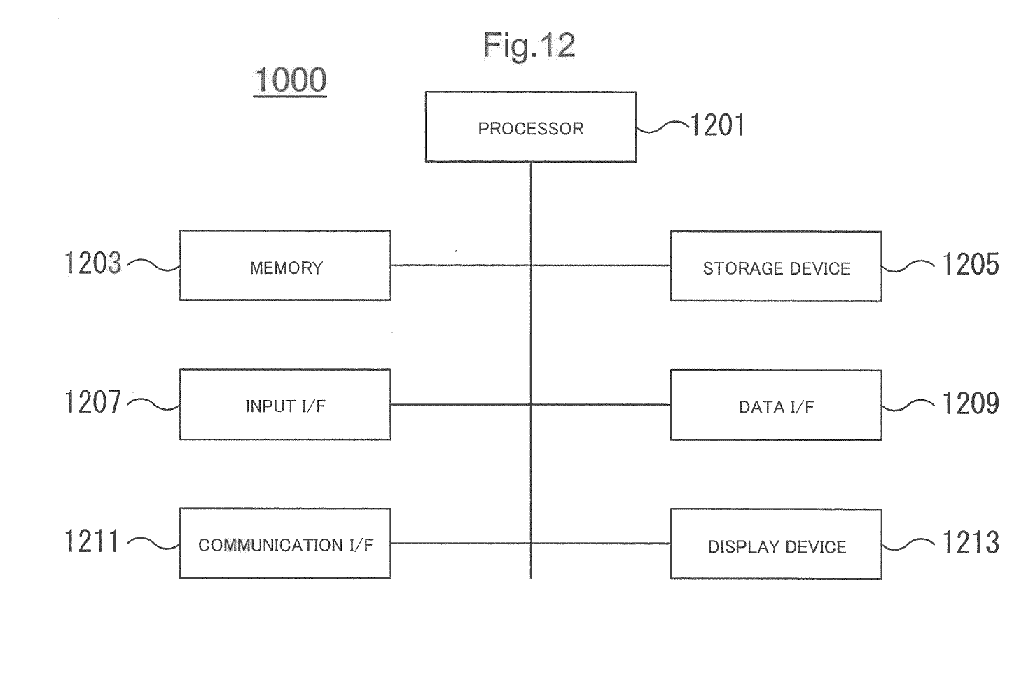

An exemplary hardware configuration of the above-described control device 1000 will be described below with reference to FIG. 12 when the device is implemented by a computer. Note that the functions of the control device 1000 can also be implemented by a plurality of information processing devices.

As illustrated in FIG. 12, the control device 1000 includes a processor 1201, a memory 1203, a storage device 1205, an input interface (I/F) 1207, a data I/F 1209, a communication I/F 1211, and a display device 1213.

The processor 1201 executes programs stored in the memory 1203 to controls various kinds of processing in the control device 1000. For example, processing relating to the production position detection unit 1001, the product type detection unit 1003, the person position detection unit 1005, the drive control unit 1007, the display control unit 1009, the effect output unit 1011, the information output unit 1013, the input unit 1015, and the line-of-sight detection unit 1017 described with reference to FIG. 10 can be implemented as programs which are temporarily stored in the memory 1203 and then run mainly on the processor 1201.

The memory 1203 is a storage medium such as a RAM (Random Access Memory), for example. The memory 1203 temporarily stores program codes of a program executed by the processor 1201 or data required during execution of the program. For example, a stack area, which is required during execution of a program, is provided in a storage region in the memory 1203.

The storage device 1205 is a nonvolatile storage device such as a hard disk or a flash memory. The storage device 1205 stores an operating system, various programs to implement the product position detection unit 1001, the product type detection unit 1003, the person position detection unit 1005, the drive control unit 1007, the display control unit 1009, the effect output unit 1011, the information output unit 1013, the input unit 1015 and the line-of-sight detection unit 1017, and various data used in the programs and other programs. The programs and data stored in the storage deice 1205 are loaded into the memory 1203 as needed and are referred to by the processor 1201.

The input I/F 1207 is a device for accepting inputs from an administrator or users C, for example. Examples of the input I/F 1207 include a keyboard, a mouse, a touch panel, and various types of sensors. The input I/F 1207 may be connected to the control device 1000 through an interface such as a USB (Universal Serial Bus).

The data I/F 1209 is a device for inputting data from outside the control device 1000. Examples of the data I/F 1209 include drive devices for reading data stored in various storage devices. The data I/F 1209 may be provided external to the control device 1000. In that case, the data I/F 1209 is connected to the control device 1000 through an interface such as a USB.

The communication I/F 1211 is a device for performing wired or wireless data communication with devices external to the control device 1000, for example devices such as the projection device 901, the detection device 903, and the drive device 905, and a light, speaker, a display, a checkout system, an in-store monitoring system, a business terminal, a personal terminal, a content control device, an advertisement distribution device, an audio distribution device, a data input device, a surveillance camera and other devices. The external input-output device 907 described with reference to FIG. 10 can be implemented by the data I/F 1209 or the communication I/F 1211 described above. The communication I/F 1211 may be provided external to the control device 1000. In that case, the communication I/F 1211 is connected to the control device 1000 through an interface such as a USB, for example.

The display device 1213 is a device for displaying various kinds of information. The projection device 901 described with reference to FIG. 10 can be implemented by the display device 1213. Examples of the display device 1213 include a projector, a liquid-crystal display, and an organic EL (Electro-luminescence) display, for example. The display device 1213 may be provided external to the control device 1000.

### (6.5 Advantageous Effects of Present Exemplary Embodiment)

As has been described above, in the display system 10 according to this exemplary embodiment, information about a product P, such as advertisement video or stock information, is projected onto a surface of the product P or in a location near the product P. This allows the attention of users C to be attracted directly to the product P itself and therefore sales can be expected to be improved as compared with a system in which an extra display for information presentation is provided. Furthermore, unlike digital signage using such a display for information presentation, the display system 10 according to this exemplary embodiment does not need provision of a dedicated screen panel and therefore the flexibility of the layout of images and the layout of products can be increased.

Furthermore, in the display system 10 according to this exemplary embodiment, power consumption can be reduced by avoiding projecting images when users C are not near products P or when users C are not looking at products P.

### 7 Sixth Exemplary Embodiment

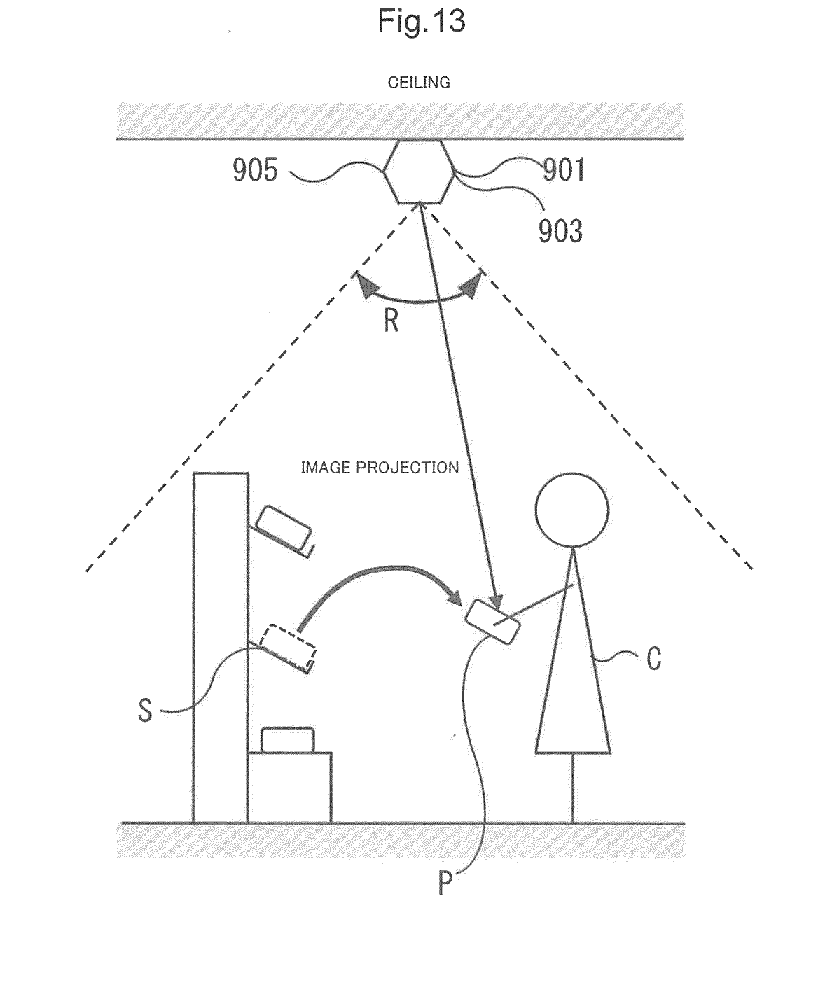

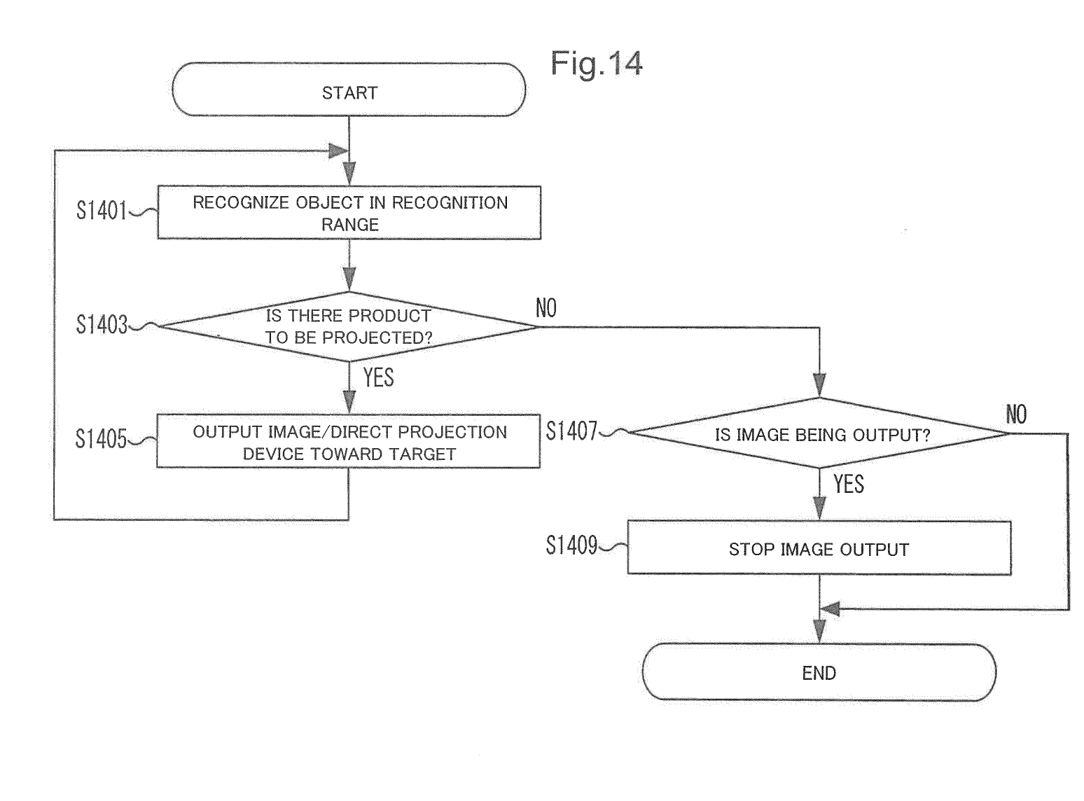

A sixth exemplary embodiment will be described below with reference to FIGS. 13 and 14. In the following description, the same reference numerals are given to the same or similar components as those of the fifth exemplary embodiment and description thereof will be omitted. Description of operations and effects the same or similar to those of the fifth exemplary embodiment will also be omitted.

### (7.1 Overview)

The sixth exemplary embodiment significantly differs from the fifth exemplary embodiment in triggering a projecting device 901 to project. A method for projecting an image onto a product P in this exemplary embodiment will be described below with reference to FIG. 13.

When a product P is on a middle or lower shelf of a showcase S as illustrated in FIG. 13 instead of the top shelf, it is difficult to project an image on the product P or a location near the product P from a projecting device 901 attached to the ceiling. The projection device 901 in this exemplary embodiment therefore starts projecting an image and a drive device 905 controls the direction/position of projection of the projection device 901 so as to display an image on a surface of a product P or in a location near the product P when the product P becomes detectable by a detection device 903 due to an action in which the product P has been taken out from the showcase and the like, i.e. when the product P enters the detection range R of the detection device 903. In this case, the approach of the user C to the product P or the contact of the user C with the product P are not necessarily need to be detected. In other words, the person position detection unit 1005 in the fifth exemplary embodiment may be omitted.

The outline of the functional configuration of the system except for the arrangement described above is the same or similar to that of the fifth exemplary embodiment described with reference to FIG. 10 and therefore description thereof will be omitted.

### (7.2 Flow of Processing)

A flow of processing in a display system 10 according to this exemplary embodiment will be described below with reference to FIG. 14. FIG. 14 is a flowchart illustrating a flow of processing by a control device 1000 according to this exemplary embodiment.

First, a product position detection unit 1001 recognizes an object in the detection range R on the basis of a result of detection by the detection device 903 (S1401). When there is a product to be projected (S1403), a display control unit 1009 causes the projection device 901 to project an image relating to the product P and a drive control unit 1007 controls a drive device 905 to direct the projection by the projection device 901 toward a surface of the product P or a location near the product P (S1405). Then the processing from S1401 to S1405 is repeated until the product P moves out of the detection range R of the detection device 903 and, when the product P has moved, the drive control unit 1007 can cause the projection of the projection device 901 to follow the product P accordingly.

When the position of the product P is out of the detection range R of the detection device 903 (No at S1403) and the projection device 901 is still outputting the image (Yes at S1407), the display control unit 1009 cause the output to stop (S1409), then the processing ends.

### (7.3 Advantageous Effects of Present Exemplary Embodiment)

As has been described above, in the display system 10 according to this exemplary embodiment, as in the fifth exemplary embodiment, information about a product P, such as advertisement video or stock information, is projected onto a surface of the product P or in a location near the product P. This allows the attention of users C to be attracted directly to the product P itself and therefore sales can be expected to be improved as compared with a system in which an extra display for information presentation is provided. Furthermore, unlike digital signage using such a display for information presentation, the display system 10 according to this exemplary embodiment does not need provision of a dedicated screen panel and therefore the flexibility of the layout of images and the layout of products can be increased.

### 8 Seventh Exemplary Embodiment

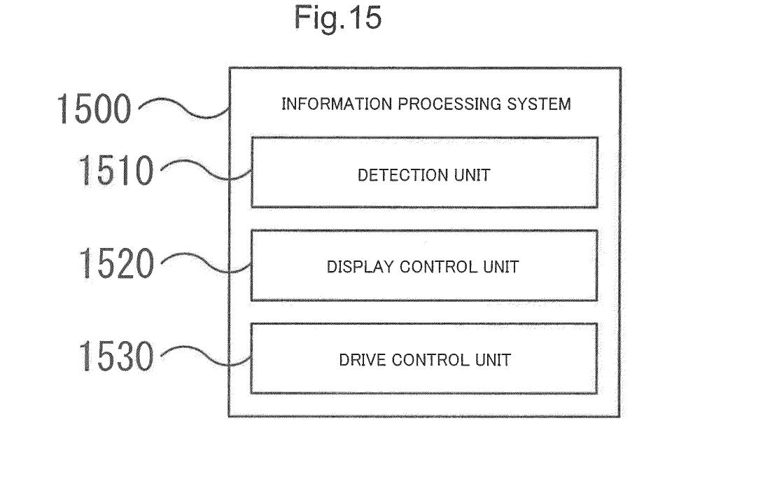

A seventh exemplary embodiment will be described with reference to FIG. 15. FIG. 15 is a block diagram illustrating a functional configuration of an information processing system 1500. As illustrated in FIG. 15, the information processing system 1500 includes a detection unit 1510, a display control unit 1520 and a drive control unit 1530.

The detection unit 1510 dynamically detects the position of an object, for example a product. The display control unit 1520 causes a projection device, not depicted, to project information based on the type of the object in a location near or on a surface of the object. The drive control unit 1530 causes the projection device to project information onto a different location in accordance with a change in the object position.

The information processing system 1500 according to this exemplary embodiment implemented in this way can suitably provide information to users.

### 9 Eighth Exemplary Embodiment

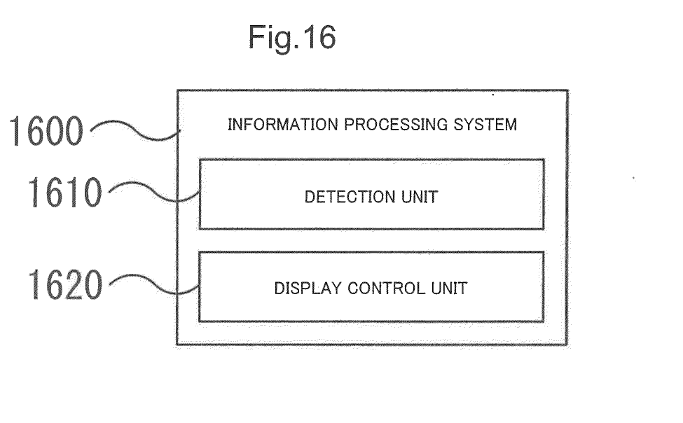

An eighth exemplary embodiment will be described below with reference to FIG. 16. FIG. 16 is a block diagram illustrating a functional configuration of an information processing system 1600. As illustrated in FIG. 16, the information processing system 1600 includes a detection unit 1610 and a display control unit 1620.

The detection unit 1610 detects an object position which is the position of an object. The display control unit 1620 causes information based on the type of the object or the type of content contained in the object to be displayed in the object position of the object or a location near the object position.

The information processing system 1600 according to this exemplary embodiment implemented in this way can suitably provide information about goods to users.

### 10 Note 2

The components of the exemplary embodiments described above may be combined or some of the components may be replaced. The configurations of the present invention are not limited to the exemplary embodiments described above; various modifications may be made to the exemplary embodiments without departing from the spirit of the present invention.

All or part of the exemplary embodiments disclosed above can be described as in, but not limited to, the following supplementary notes. The programs of the present invention may be a program that causes a computer to execute the operations described in the exemplary embodiments illustrated above.

### (Supplementary Note 1)

An information processing system including a first detection means for detecting an object position which is the position of an object, and a display control means for causing information based on the type of the object or the type of a content contained in the object to be displayed in the object position of the object or near the object position.

### (Supplementary Note 2)

The information processing system according to Supplementary Note 1, wherein the object is a container containing the content, and the information processing system further includes a second detection means for detecting the type of the content contained in the object.

### (Supplementary Note 3)

The information processing system according to Supplementary Note 2, further including a third detection means for detecting a content position which is the position of the content contained in the object, wherein the display control means displays information based on the type of the content in the content position or a position near the content position in accordance with the content position.

### (Supplementary Note 4)

The information processing system according to Supplementary Note 3, wherein the display control means displays information based on the type of the content in a position in the object position other than the content position.

### (Supplementary Note 5)

The information processing system according to any one of Supplementary Notes 2 to 4, wherein the second detection means detects the type of the content contained in the object by detecting transfer of the content from a showcase in which the content is placed.

### (Supplementary Note 6)

The information processing system according to any one of Supplementary Notes 2 to 5, wherein the first detection means detects the orientation of the object together with the object position and the display control means changes the orientation in which the information based on the type of the content is displayed in accordance with the orientation of the object.

### (Supplementary Note 7)

The information processing system according to any one of Supplementary Notes 2 to 6, wherein the display control means displays information based on the type of the content on a display device located near the object position among a plurality of display devices.

### (Supplementary Note 8)

The information processing system according to any one of Supplementary Note 2 to 7, wherein the display control means displays information based on the type of the content by using a projector.

### (Supplementary Note 9)

The information processing system according to any one of Supplementary Notes 2 to 8, further including an input means for accepting an input from a user, wherein the display control means changes information based on the type of the content in accordance with an input from a user.

### (Supplementary Note 10)

The information processing system according to any one of Supplementary Notes 2 to 9, further including a means for identifying information relating to a user, wherein the display control means changes information based on the type of the content in accordance with information relating to a user.

### (Supplementary Note 11)

The information processing system according to any one of Supplementary Notes 2 to 10, wherein the second detection means detects a price for the content contained in the object.

### (Supplementary Note 12)

The information processing system according to Supplementary Note 1, wherein the first detection means dynamically detects the object position and the display control means causes a projection device to project information based on the type of the object onto a position near the object or onto a surface of the object, the information processing system further includes a drive control means for changing the position to which the projection device projects the information in accordance with a change in the object position.

### (Supplementary Note 13)

The information processing system according to Supplementary Note 12, wherein the first detection means detects a position of a person and the display control means turns on and off the display of information in accordance with the position of the person.

### (Supplementary Note 14)

The information processing system according to Supplementary Note 12 or 13, further including a means for detecting the shape of the object and a means for identifying the type of the object on the basis of the shape of the object.

### (Supplementary Note 15)

The information processing system according to Supplementary Note 12 or 13, further including a means for identifying the type of the object on the basis of the object position.

### (Supplementary Note 16)

The information processing system according to any one of Supplementary Notes 12 to 15, wherein the first detection means detects a surface condition of the object and the display control means changes information to be projected on the basis of the surface condition of the object.

### (Supplementary Note 17)

The information processing system according to any one of Supplementary Notes 12 to 16, further including an output means for outputting information to at least any one of an externally-connected light, speaker, display, checkout system, in-store monitoring system, business terminal and personal terminal.

### (Supplementary Note 18)

The information processing system according to any one of Supplementary Notes 12 to 17, further including: an input means for accepting input information from at least any one of an externally-connected content control device, advertisement distribution device, audio distribution device, business terminal, personal terminal, data input device, in-store monitoring system, checkout system and surveillance camera; and a control means for performing control on the basis of the input information.

### (Supplementary Note 19)

The information processing system according to any one of Supplementary Notes 12 to 18, wherein the first detection means detects the direction of the line of sight of a person and the display control means causes the projection device to project information based on the type of the object when it is estimated that the object is within a range of the view field of a person.

### (Supplementary Note 20)

An information processing method including the steps of: detecting an object position which is the position of an object; and causing information based on the type of the object or the type of a content contained in the object to be displayed in the object position of the object or near the object position.

### (Supplementary Note 21)

The information processing method according to Supplementary Note 20, wherein the object is a container containing the content, and the information processing method further includes the step of detecting the type of the content contained in the object.

### (Supplementary Note 22)

The information processing method according to Supplementary Note 21, further including the step of detecting a content position which is the position of the content contained in the object, wherein information based on the type of the content is displayed in the content position or a position near the content position in accordance with the content position.

### (Supplementary Note 23)

The information processing method according to Supplementary Note 22, wherein information based on the type of the content is displayed in a position in the object position other than the content position.

### (Supplementary Note 24)

The information processing method according to any one of Supplementary Notes 21 to 23, wherein the type of the content contained in the object is detected by detecting transfer of the content from a showcase in which the content is placed.

### (Supplementary Note 25)

The information processing method according to any one of Supplementary Notes 21 to 24, wherein the orientation of the object is detected together with the object position and the orientation in which the information based on the type of the content is displayed is changed in accordance with the orientation of the object.

### (Supplementary Note 26)

The information processing method according to any one of Supplementary Notes 21 to 25, wherein information based on the type of the content is displayed on a display device located near the object position among a plurality of display devices.

### (Supplementary Note 27)

The information processing method according to any one of 21 to 26, wherein information based on the type of the content is displayed by using a projector.

### (Supplementary Note 28)

The information processing method according to any one of Supplementary Notes 21 to 27, further including the step of accepting an input from a user, wherein information based on the type of the content is changed in accordance with an input from a user.

### (Supplementary Note 29)

The information processing method according to any one of supplementary Notes 21 to 28, further including the step of identifying information relating to a user, wherein information based on the type of the content is changed in accordance with information relating to a user.

### (Supplementary Note 30)

The information processing method according to any one of Supplementary Notes 21 to 29, wherein a price for the content contained in the object is detected.

### (Supplementary Note 31)

The information processing method according to Supplementary Note 20, further including the step of dynamically detecting the object position, causing a projection device to project information based on the type of the object onto a position near the object or onto a surface of the object, and changing the position to which the projection device projects the information in accordance with a change in the object position.

### (Supplementary Note 32)

The information processing method according to Supplementary Note 31, wherein a position of a person is detected and the display of information is turned on and off in accordance with the position of the person.

### (Supplementary Note 33)

The information processing method according to Supplementary Note 31 or 32, further including the steps of detecting the shape of the object and identifying the type of the object on the basis of the shape of the object.

### (Supplementary Note 34)

The information processing method according to Supplementary Note 31 or 32, further including the step of identifying the type of the object on the basis of the object position.

### (Supplementary Note 35)

The information processing method according to any one of Supplementary Notes 31 to 34, wherein a surface condition of the object is detected and information to be projected is changed on the basis of the surface condition of the object.

### (Supplementary Note 36)

The information processing method according to any one of Supplementary Notes 31 to 35, further including the step of outputting information to at least any one of an externally-connected light, speaker, display, checkout system, in-store monitoring system, business terminal and personal terminal.

### (Supplementary Note 37)

The information processing method according to any one of Supplementary Notes 31 to 36, further including the steps of accepting input information from at least any one of an externally-connected content control device, advertisement distribution device, audio distribution device, business terminal, personal terminal, data input device, in-store monitoring system, checkout system and surveillance camera and performing control on the basis of the input information.

### (Supplementary Note 38)

The information processing method according to any one of Supplementary Notes 31 to 37, wherein the direction of the line of sight of a person is detected and the projection device is caused to project information based on the type of the object when it is estimated that the object is within a range of the view field of a person.

This application is based upon and claims benefit of priority from Japanese Patent Application No. 2013-040623 and Japanese Patent Application No. 2013-040620, filed on Mar. 1, 2013, the entire disclosure of which is incorporated herein.

### REFERENCE SIGNS LIST

1 . . . Display system, 10 . . . Display system, 101 . . . Display device, 103 . . . Detection device, 105 . . . Input device, 107 . . . External output device, 200 . . . Control device, 201 . . . Container position detection device, 203 . . . Product type detection unit, 205 . . . Product position detection unit, 207 . . . Information generation unit, 209 . . . display control unit, 211 . . . Input unit, 213 . . . Purchaser identification unit, 401 . . . Processor, 403 . . . Memory, 405 . . . Storage device, 407 . . . Input interface, 409 . . . Data I/F, 411 . . . , Communication interface, 413 . . . Display device, 800 . . . Information processing system, 810 . . . First detection unit, 820 . . . Second detection unit, 830 . . . Display control unit, 901 . . . Projection device, 903 . . . Detection device, 905 . . . Drive device, 907 . . . External input-output device, 1000 . . . Control device, 1001 . . . Product position detection unit, 1003 . . . Product type detection unit, 1005 . . . Person position detection unit, 1007 . . . Drive control unit, 1009 . . . Display control unit, 1011 . . . Effect output unit, 1013 . . . Information output unit, 1015 . . . Input unit, 1017 . . . Line-of-sight detection unit, 1201 . . . Processor, 1203 . . . memory, 1205 . . . Storage device, 1207 . . . Input interface, 1209 . . . Data interface, 1211 . . . Communication interface, 1213 . . . Display device, 1500 . . . Information processing system, 1510 . . . Detection unit, 1520 . . . Display control unit, 1530 . . . Drive control unit, 1600 . . . Information processing system, 1610 . . . Detection unit, 1620 . . . Display control unit

What is claimed is:

1. An information processing system comprising:
a first detection unit configured to detect an object position which is the position of an object; and
a display control unit configured to cause information based on the type of the object or the type of a content contained in the object to be displayed in the object position or near the object position.

2. The information processing system according to claim 1, wherein
the object is a container containing the content, and
the information processing system further comprises a second detection unit configured to detect the type of the content contained in the object.

3. The information processing system according to claim 2, further comprising
a third detection unit configured to detect a content position which is the position of the content contained in the object,
where in the display control unit displays information based on the type of the content in the content position or a position near the content position in accordance with the content position.

4. The information processing system according to claim 3, wherein
the display control unit displays information based on the type of the content in a position in the object position other than the content position.

5. The information processing system according to claim 2, wherein
the second detection unit detects the type of the content contained in the object by detecting transfer of the content from a showcase in which the content is placed.

6. The information processing system according to claim 2, wherein
the first detection unit detects the orientation of the object together with the object position, and
the display control unit changes the orientation in which the information based on the type of the content is displayed in accordance with the orientation of the object.

7. The information processing system according to claim 2, wherein
the display control unit displays information based on the type of the content on a display device located near the object position among a plurality of display devices.

8. The information processing system according to claim 2, wherein
the display control unit displays information based on the type of the content by using a projector.

9. The information processing system according to claim 2, further comprising
an input unit configured to accept an input from a user,
wherein the display control unit changes information based on the type of the content in accordance with an input from a user.

10. The information processing system according to claim 2, further comprising
a unit configured to identify information relating to a user,
wherein the display control unit changes information based on the type of the content in accordance with information relating to a user.

11. The information processing system according to claim 2, wherein
the second detection unit detects a price for the content contained in the object.

12. The information processing system according to claim 1, wherein
the first detection unit dynamically detects the object position, and
the display control unit causes a projection device to project information based on the type of the object onto a position near the object or onto a surface of the object,
the information processing system further comprises a drive control unit configured to change the position to which the projection device projects the information in accordance with a change in the object position.

13. The information processing system according to claim 12, wherein
the first detection unit detects a position of a person, and
the display control unit turns on and off the display of information in accordance with the position of the person.

14. The information processing system according to claim 12, further comprising:
a unit configured to detect the shape of the object; and
a unit configured to identify the type of the object on the basis of the shape of the object.

15. The information processing system according to claim 12, further comprising a unit configured to identify the type of the object on the basis of the object position.

16. The information processing system according to claim 12, wherein
the first detection unit detects a surface condition of the object, and
the display control unit changes information to be projected on the basis of the surface condition of the object.

17. The information processing system according to claim 12, further comprising
an output unit configured to output information to at least any one of an externally-connected light, speaker, display, checkout system, in-store monitoring system, business terminal and personal terminal.

18. The information processing system according to claim 12, further comprising:
an input unit configured to accept input information from at least any one of an externally-connected content control device, advertisement distribution device, audio distribution device, business terminal, personal terminal, data input device, in-store monitoring system, checkout system and surveillance camera; and
a control unit configured to perform control on the basis of the input information.

19. The information processing system according to claim 12, wherein
the first detection unit detects the direction of the line of sight of a person, and
the display control unit causes the projection device to project information based on the type of the object when it is estimated that the object is within a range of the view field of a person.

20. An information processing method comprising:
detecting an object position which is the position of an object; and
causing information based on the type of the object or the type of a content contained in the object to be displayed in the object position of the object or near the object position.
